(19) United States
(12) Patent Application Publication
(10) Pub. No.: US 2020/0033159 A1
(43) Pub. Date: Jan. 30, 2020

(54) MAGNETIC ROTATION SENSOR

(71) Applicant: HAMLIN ELECTRONICS (SUZHOU) LTD., Suzhou, Jiangsu (CN)

(72) Inventors: Jeffrey ZHAO, Suzhou, Jiangsu (CN); Sophie YU, Suzhou, Jiangsu (CN); Seong-Jae LEE, Suzhou, Jiangsu (CN)

(73) Assignee: HAMLIN ELECTRONICS (SUZHOU) LTD., Suzhou, Jiangsu (CN)

(21) Appl. No.: 16/499,300

(22) PCT Filed: Mar. 30, 2017
(86) PCT No.: PCT/CN2017/078788

§ 371 Date: Sep. 29, 2019

(51) Int. Cl. G01D 5/14

(52) U.S. Cl. CPC G01D 5/147; G01P 3/487

(57) ABSTRACT

Magnetic field sensors are disclosed. Furthermore, a method for providing magnetic field sensors is disclosed. In one implementation, a magnetic field sensor includes a magnet and a magnetic field sensing element. In some implementations, the magnet at least partially surrounds the magnetic field sensing element. Specifically, in some implementations, the magnet includes a cavity defined by one or more surfaces of the magnet. In some implementations, the magnetic field sensing element is disposed in the cavity.

### BACKGROUND

### Field

The present invention relates generally to magnetic field sensors and, more particularly, to magnetic field sensors for detecting rotation and/or speed of a ferromagnetic object.

### Description of Related Art

Magnetic field sensors generally include a magnetic field sensing element and other electronic components. Some magnetic field sensors also include a fixed permanent magnet arranged in a particular position in proximity to the magnetic field sensing element.

Magnetic field sensors provide an electrical signal representative of a sensed magnetic field. In some examples, the magnetic field sensor provides information about a sensed ferromagnetic object by sensing fluctuations of the magnetic field associated with the permanent magnet of the magnetic field sensor as the object moves within a magnetic field generated by the magnet. In the presence of a moving ferromagnetic object, the magnetic field signal sensed by the magnetic field sensor varies in accordance with a shape and/or profile of the moving ferromagnetic object.

Magnetic field sensors may be used to detect movement of features associated with a ferromagnetic gear, such as gear teeth and/or gear slots associated with a gear element in a vehicle transmission. A magnetic field sensor in this application may be referred to as a transmission gear speed sensor. Transmission gear speed sensors are used, for example, in automotive applications to detect the rotation speed of a shaft coupled to one or more gears of the transmission, provide information to a transmission control unit (TCU) to enable dashboard display of speed and distance, and for other operations.

In some applications, the signal amplitude produced by magnetic field sensors may be inadequate to provide robust movement data associated with a ferromagnetic gear. In some conventional magnetic speed sensing arrangements, a magnetic sensor is positioned adjacent to the ferromagnetic gear surface and a permanent magnet is coupled to the magnetic sensor. Two important factors in determining a signal amplitude provided by magnetic field sensors are magnet grade and an air gap between the magnetic field sensor and the gear surface.

The signal amplitude produced by conventional magnetic field sensors may be increased using relatively large magnets and/or high-grade magnets. However, the use of a large magnet and/or a high-grade magnet undesirably increases the cost of producing and manufacturing an associated magnetic field sensor. The signal amplitude produced by conventional magnetic field sensors may also be increased by reducing the air gap between the magnetic field sensor and the gear surface. However, in some implementations, implementation specific parameters restrict reducing air gap between the magnetic field sensor and the gear surface.

Other problems with conventional magnetic field sensors will become apparent in view of the disclosure below.

### SUMMARY

Magnetic field sensors are disclosed. Furthermore, a method for providing magnetic field sensors is disclosed. In one implementation, a magnetic field sensor includes a magnet and a magnetic field sensing element. In one implementation, the magnetic field sensing element is a Hall-effect type sensor. In another implementation, the magnetic field sensing element is a magnetoresistance element. For example, the magnetic field sensing element may be semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, or a magnetic tunnel junction (MTJ).

In some implementations, the magnetic field sensor includes a magnet that is arranged in proximity to the magnetic field sensing element. The magnet may be a permanent magnet. In some implementations, the magnet is a cylindrical magnet. In other implementations, the magnet is a rectangular cuboid magnet. In some implementations, the magnet at least partially surrounds the magnetic field sensing element. Specifically, in some implementations, the magnet includes a cavity defined by one or more surfaces of the magnet. In some implementations, the magnetic field sensing element is disposed in the cavity.

In some implementations, an apparatus includes a magnetic field sensor element; and a magnet including a cavity, the cavity defined by at least one interior surface of the magnet, the magnetic field sensor element disposed in the cavity.

In further implementations, a method includes providing a magnet including a cavity, the cavity defined by at least one interior surface of the magnet; and arranging a magnetic field sensor element in the cavity.

### BRIEF DESCRIPTION OF THE DRAWINGS

FIG. 1 illustrates a first implementation of a magnetic field sensor arrangement, according to an embodiment of the disclosure.

FIG. 2 illustrates a second implementation of a magnetic field sensor arrangement, according to an embodiment of the disclosure.

FIG. 3 illustrates a third implementation of a magnetic field sensor arrangement, according to an embodiment of the disclosure.

FIG. 4 illustrates a fourth implementation of a magnetic field sensor arrangement, according to an embodiment of the disclosure.

FIG. 5 illustrates a fifth implementation of the magnetic field sensor arrangement, according to an embodiment of the disclosure.

FIG. 6 illustrates an exemplary set of operations for manufacturing a magnetic field sensor arrangement, according to an embodiment of the disclosure.

### DETAILED DESCRIPTION

In one implementation, a magnetic field sensor includes a magnet and a magnetic field sensing element. In one implementation, the magnetic field sensing element is a Hall-effect type sensor. In another implementation, the magnetic field sensing element is a magnetoresistance element. For example, the magnetic field sensing element may be semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, or a magnetic tunnel junction (MTJ).

Furthermore, in some implementations, the magnetic field sensor includes a magnet that is arranged in proximity to the magnetic field sensing element. The magnet may be a permanent magnet. In some implementations, the magnet is a cylindrical magnet. In other implementations, the magnet is a rectangular cuboid magnet. In some implementations, the magnet at least partially surrounds the magnetic field sensing element. Specifically, in some implementations, the magnet includes a cavity defined by one or more surfaces of the magnet. In some implementations, the magnetic field sensing element is disposed in the cavity.

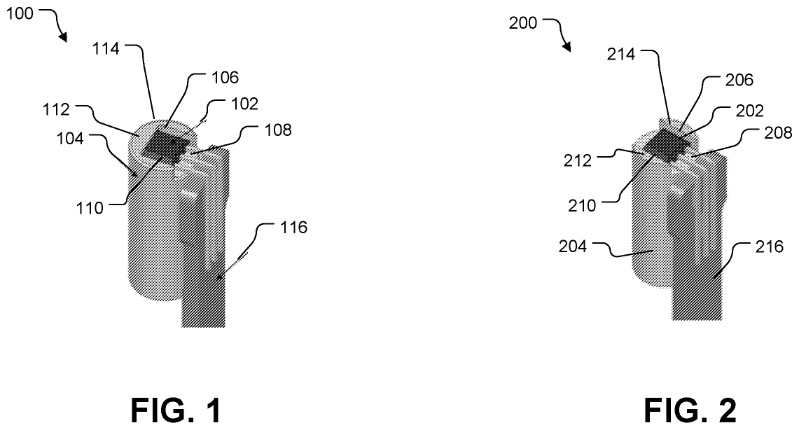

FIG. 1 illustrates a first implementation of a magnetic field sensor arrangement 100, according to an embodiment of the disclosure. The magnetic field sensor arrangement 100 includes a magnetic field sensor element 102 and a magnet 104. The magnet 104 may include a cavity 106. The magnetic field sensor element 102 may be disposed in the cavity 106. In some implementations, the magnetic field sensor element 102 is adhesively coupled to a surface 108 of the cavity 106. In some implementations, a top surface 110 of the magnetic field sensor element 102 is planar with an exposed surface portion 112 of an end surface 114 of the magnet 104. In some implementations, the magnet 104 is a cylindrical magnet. In some implementations, the magnet 104 is a rectangular cuboid magnet. In some implementations, as illustrated, the cavity 106 at least a partially surrounds the magnetic field sensor element 102. Specifically, in some implementations, at least three surfaces of the cavity 106 surrounds the magnetic field sensor element 102.

The magnetic field sensor element 102 may be electrically coupled to a printed circuit board (PCB) 116. The magnetic field sensor element 102 may produce one or more electrical output signals indicative of the changes associated with a magnetic field generated by the magnet 104. The produced one or more electrical output signals may be conveyed to one or more circuit elements (not illustrated) associated with the PCB 116.

FIG. 2 illustrates a second implementation of a magnetic field sensor arrangement 200, according to an embodiment of the disclosure. The magnetic field sensor arrangement 200 includes a magnetic field sensor element 202 and a magnet 204. The magnet 204 may include a cavity 206. The magnetic field sensor element 202 may be disposed in the cavity 206. In some implementations, the magnetic field sensor element 202 is adhesively coupled to a surface 208 of the cavity 206. In some implementations, a top surface 210 of the magnetic field sensor element 202 is planar with an exposed surface portion 212 of an end surface 214 of the magnet 204. In some implementations, the magnet 204 is a cylindrical magnet. In some implementations, the magnet 204 is a rectangular cuboid magnet. In some implementations, as illustrated, the cavity 206 at least a partially surrounds the magnetic field sensor element 202. Specifically, in some implementations, at least two surfaces of the cavity 206 surround the magnetic field sensor element 202.

The magnetic field sensor element 202 may be electrically coupled to a printed circuit board (PCB) 216. The magnetic field sensor element 202 may produce one or more electrical output signals indicative of the changes associated with a magnetic field generated by the magnet 204. The produced one or more electrical output signals may be conveyed to one or more circuit elements (not illustrated) associated with the PCB 216.

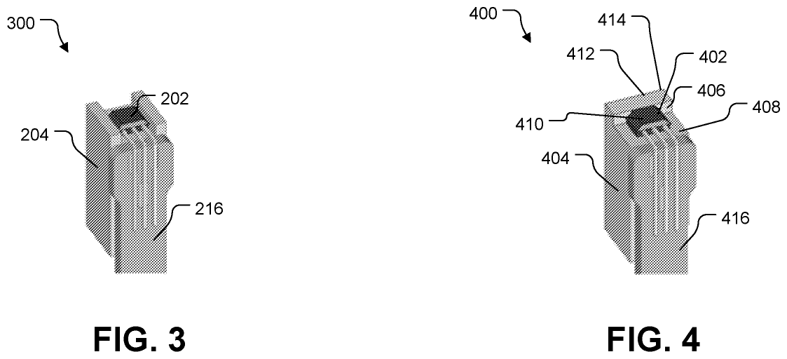

FIG. 3 illustrates a third implementation of the magnetic field sensor arrangement 300, according to an embodiment of the disclosure. The magnetic field sensor arrangement 300 illustrated in FIG. 3 includes the same elements illustrated in FIG. 2. However, in FIG. 3, the magnet 204 is shown as a rectangular cuboid magnet.

FIG. 4 illustrates a fourth implementation of a magnetic field sensor arrangement 400, according to an embodiment of the disclosure. The magnetic field sensor arrangement 400 includes a magnetic field sensor element 402 and a magnet 404. The magnet 404 may include a cavity 406. The magnetic field sensor element 402 may be disposed in the cavity 406. In some implementations, the magnetic field sensor element 402 is adhesively coupled to a surface 408 of the cavity 406. In some implementations, a top surface 410 of the magnetic field sensor element 410 is planar with an exposed surface portion 412 of an end surface 414 of the magnet 404. In some implementations, the magnet 404 is a cylindrical magnet. In some implementations, the magnet 404 is a rectangular cuboid magnet. In some implementations, as illustrated, the cavity 406 at least a partially surrounds the magnetic field sensor element 402. Specifically, in some implementations, at least one surface of the cavity 406 is adjacent and partially surrounds the magnetic field sensor element 402.

The magnetic field sensor element 402 may be electrically coupled to a printed circuit board (PCB) 416. The magnetic field sensor element 402 may produce one or more electrical output signals indicative of the changes associated with a magnetic field generated by the magnet 404. The produced one or more electrical output signals may be conveyed to one or more circuit elements (not illustrated) associated with the PCB 416.

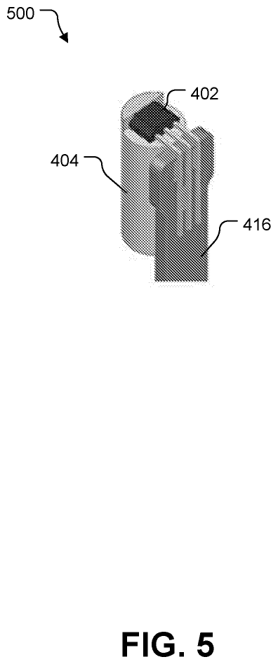

FIG. 5 illustrates a fifth implementation of the magnetic field sensor arrangement 500, according to an embodiment of the disclosure. The magnetic field sensor arrangement 500 illustrated in FIG. 5 includes the same elements illustrated in FIG. 4. However, in FIG. 5, the magnet 404 is shown as a cylindrical magnet.

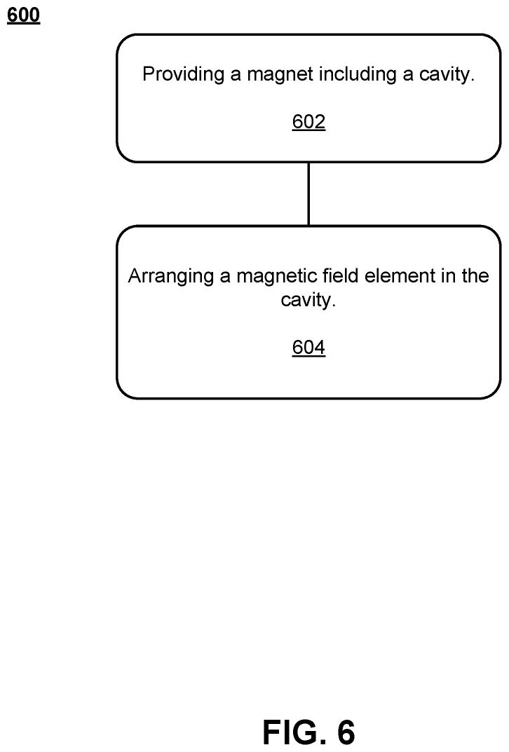

FIG. 6 illustrates an exemplary set of operations 500 for manufacturing a magnetic field sensor arrangement 100/200/300/400/500, according to an embodiment of the disclosure. At block 602, a magnet including a cavity is provided. At block 604, a magnetic field sensor element is arranged in the cavity.

The magnetic field sensor arrangements 100, 200, 300, 400 and/or 500 may be positioned adjacent to a transmission gear. The transmission gear may include a plurality of teeth. Moreover, the transmission gear may be rotatably supported by a shaft. Therefore, the transmission gear may rotate. The magnetic field sensor arrangement 100, 200, 300, 400 and/or 500, in some implementations, is responsive to the ferromagnetic gear teeth associated with the transmission gear. Specifically, the magnetic field sensor element of the magnetic field sensor arrangement 100, 200, 300, 400 and/or 500 may generate an output signal that relates to a magnetic field revealing of whether the magnetic field sensor element is over a gear tooth are gear valley. The output signal may have an associated frequency indicative of a speed of rotation of the transmission gear. Therefore, the magnetic field sensor arrangement 100, 200, 300, 400 and/or 500 may detect a rotation of the transmission gear as well as a speed of the rotation of the transmission gear.

Arranging a magnetic field sensor element in a cavity, such as described and illustrated herein, provides numerous advantages. Specifically, the implementations described herein enhance magnetic flux detection by the magnetic field sensor arrangement without the use of larger permanent magnets and/or high-grade magnets. In some implementations, at least a 21% increase in magnetic flux detection is achieved compared to the magnetic flux detection realized by conventional magnetic field sensors. Furthermore, the magnetic field sensor arrangements described herein allow for the use of a smaller air gap, compared to conventional magnetic field sensors, between ferromagnetic objects and the magnetic field sensor arrangements. In some implementations, the magnetic field sensor arrangements described herein allow for the use of a larger air gap, compared to conventional magnetic field sensors, between ferromagnetic objects and the magnetic field sensor arrangements, while still attaining acceptable magnetic flux detection by the magnetic field sensor arrangements.

While magnetic field sensor arrangements and a method for manufacturing magnetic field sensor arrangements have been described with reference to certain embodiments, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. Therefore, the claims should not be construed as being limited to any one of the particular embodiments disclosed, but to any embodiments that fall within the scope of the claims.

We claim:

1. An apparatus, comprising:
a magnetic field sensor element; and
a magnet including a cavity, the cavity defined by at least one interior surface of the magnet, the magnetic field sensor element disposed in the cavity.

2. The apparatus according to claim 1, wherein the magnetic field sensor element is a Hall-effect type sensor.

3. The apparatus according to claim 1, wherein the magnet is a cylindrical magnet and the cavity is disposed in an end surface of the cylindrical magnet, the magnetic field sensor element disposed in the cavity such that a top surface of the magnetic field sensor element is planar with an exposed surface portion of the end surface of the cylindrical magnet.

4. The apparatus according to claim 1, wherein the magnet is a rectangular cuboid magnet and the cavity is disposed in an end surface of the rectangular cuboid magnet, the magnetic field sensor element disposed in the cavity such that a top surface of the magnetic field sensor element is planar with an exposed surface portion of the end surface of the rectangular cuboid magnet.

5. The apparatus according to claim 1, wherein the cavity is defined by at least two interior surfaces of the magnet.

6. The apparatus according to claim 1, wherein the cavity is defined by at least three interior surfaces of the magnet.

7. The apparatus according to claim 1, wherein the magnetic field sensor element is adhesively attached to at least one surface of the cavity.

8. A method, comprising:
providing a magnet including a cavity, the cavity defined by at least one interior surface of the magnet; and
arranging a magnetic field sensor element in the cavity.

9. The method according to claim 8, wherein the magnetic field sensor element is a Hall-effect type sensor.

10. The method according to claim 8, wherein the magnet is a cylindrical magnet and the cavity is disposed in an end surface of the cylindrical magnet, the magnetic field sensor element disposed in the cavity such that a top surface of the magnetic field sensor element is planar with an exposed surface portion of the end surface of the cylindrical magnet.

11. The method according to claim 8, wherein the magnet is a rectangular cuboid magnet and the cavity is disposed in an end surface of the rectangular cuboid magnet, the magnetic field sensor element disposed in the cavity such that a top surface of the magnetic field sensor element is planar with an exposed surface portion of the end surface of the rectangular cuboid magnet.

12. The method according to claim 8, wherein the cavity is defined by at least two interior surfaces of the magnet.

13. The method according to claim 8, wherein the cavity is defined by at least three interior surfaces of the magnet.

14. The method according to claim 8, comprising adhesively attaching the magnetic field sensor element to at least one surface of the cavity.
